(19) United States
(12) Patent Application Publication
(10) Pub. No.: US 2018/0230362 A1
(43) Pub. Date: Aug. 16, 2018

(54) Formation Stabilizing Fracturing Fluid and Method of Use

(71) Applicant: Halliburton Energy Services, Inc., Houston, TX (US)

(72) Inventors: Prashant D. Chopade, Kingwood, TX (US); Ajish Potty, Missouri City, TX (US)

(73) Assignee: Halliburton Energy Services, Inc., Houston, TX (US)

(21) Appl. No.: 15/763,012

(22) PCT Filed: Oct. 22, 2015
(86) PCT No.: PCT/US2015/056911

§ 371 Date: Mar. 23, 2018

(51) Int. Cl. C09K 8/68; C09K 8/88; C09K 8/90; C09K 8/80

(52) U.S. Cl. CPC C09K 8/68; C09K 8/885; C09K 8/845; C09K 8/80; C09K 8/90

(57) ABSTRACT

A fracturing fluid comprises an aqueous base fluid and a cationic polymer combined with a salt. The fracturing fluid may be used to fracture a subterranean formation. The cationic polymer in combination with a salt provides for reduced clay swelling, while maintaining the granularity and porosity of the formation, which thereby promotes the flow of hydrocarbons from the formation.

### BACKGROUND

This section is intended to provide the reader with background information to facilitate a better understanding of the various aspects of the described embodiments. Accordingly, it should be understood that these statements are to be read in this light and not as admissions of prior art.

Hydraulic fracturing operations are often carried out on oil and gas wells to increase the flow of oil and natural gas from the wells. In hydraulic fracturing, fracturing fluid is pumped into a wellbore at high pressure to fracture the formation surrounding the wellbore. The fracturing fluid transports and deposits the proppant into the fractures. The proppant holds the fractures open after the fracturing fluid flows back into the wellbore from the formation. Polymers and/or surfactants may also be added to the fracturing fluid to increase its viscosity or other performance characteristics.

Production of oil and gas may be affected by the presence of clay as well as fines that are capable of migrating in the subterranean formation. Typically, the clays and fines are stable and do not obstruct the flow of hydrocarbons through the formation. However, when the clays or fines are disturbed, such as by contact with aqueous hydraulic fracturing fluids, the clays can swell or the fines can migrate within the formation matrix and/or through the fractures in the formation, thereby resulting in a loss of formation permeability and fracture conductivity which impedes fluid flow.

One method to reduce the swelling of clay involves converting the clay from a swelling form to a lesser swelling form by cation exchange through the addition of various salts to the aqueous fracturing fluids. Salts such as potassium chloride, calcium chloride, sodium chloride, ammonium chloride and the like may be dissolved in the aqueous fracturing fluid. The solubilized salts affect ion exchange with the charged particles comprising the clays, and thereby act to reduce swelling of the clays when contacted with aqueous fracturing fluid. Salt treatments may comprise the addition of 2 to 7 wt. % salt to the formation fracturing fluid. In practice, the addition of salt to the fracturing fluid can be a labor intensive and time consuming process, as the salt must be removed from its packaging and then dissolved in the fracturing fluid.

### BRIEF DESCRIPTION OF THE DRAWINGS

For a detailed description of the embodiments of the invention, reference will now be made to the accompanying drawings in which:

FIG. 1 depicts a schematic view of a subterranean formation and a fracturing system, according to one or more embodiments;

FIG. 2 illustrates clay samples treated with various fracturing fluids;

FIG. 3 illustrates an enlarged view of clay samples from FIG. 2.

### DETAILED DESCRIPTION

The embodiments generally relate to hydraulic fracturing in subterranean operations, and more specifically, to a fracturing fluid comprising a formation swelling stabilizer to minimize swelling of the formation during subterranean operations. The fracturing fluid can comprise a cationic polymer and a salt, the combination of which acts to stabilize formation swelling and decrease any reduction in the permeability of the formation.

### Hydraulic Fracturing System

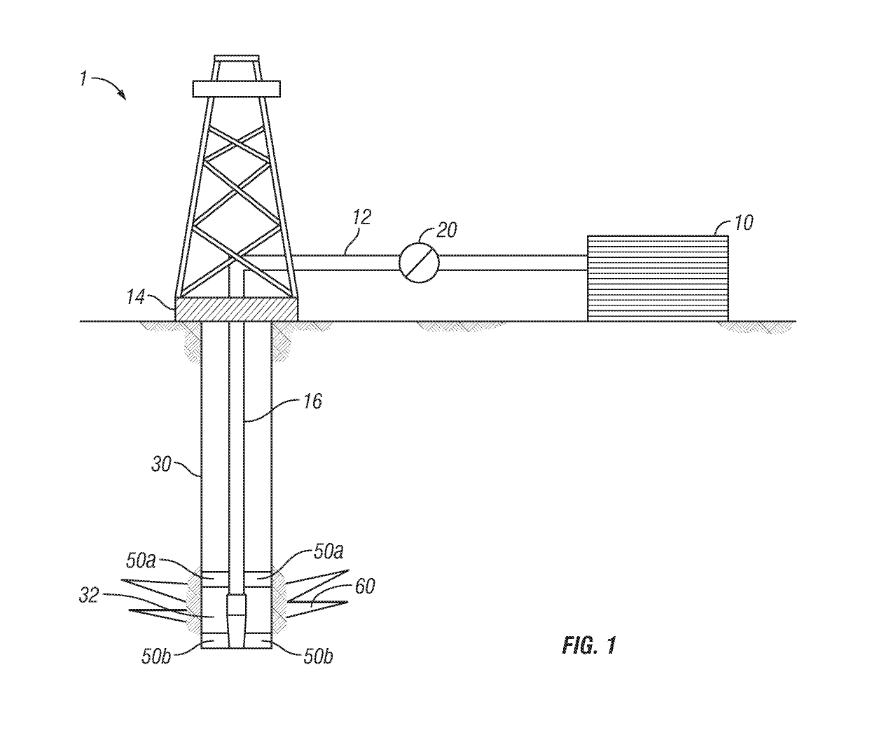

FIG. 1 depicts a schematic view of a hydraulic fracturing system 1 for fracturing a formation utilizing a below-described fracturing fluid comprising a salt and cationic polymer. While FIG. 1 depicts a land-based system, it is to be recognized that like systems may also be operated in offshore locations for subsea wells.

Although shown as vertical, the wellbore 30 may include horizontal, vertical deviating to horizontal, slant, curved, and other types of wellbore geometries and orientations, and the fracturing fluid may be applied to a subterranean zone surrounding any portion of the wellbore. The wellbore 30 can include a casing that is cemented or otherwise secured to the wellbore wall. The wellbore 30 can be uncased or include uncased sections. In cased wells, perforations can be formed using shape charges, a perforating gun, hydro-jetting and/or other tools.

In one or more embodiments, the hydraulic fracturing system 1 can be configured for delivering the fracturing fluids described herein to a downhole location. In various embodiments, the hydraulic fracturing system 1 can comprise a pump 20 that is fluidly coupled to line 12 which is used to transport fracturing fluid from a mixing/storage tank 10 to the wellhead 14, where the fracturing fluid enters working string 16 which extends from the wellhead 14 to the desired treatment zone 32. As used herein, the term “treatment zone” is used to refer to an interval of rock along a wellbore into which fracturing fluid is directed to flow from the wellbore.

In one or more embodiments, the mixing/storage tank 10 can be used to formulate the fracturing fluid described below. When formulating the fracturing fluid, salt is first mixed with an aqueous base fluid, after which a cationic polymer is added to the mixture. Once the salt and cationic polymer have been incorporated into the aqueous base fluid, additional additives, including but not limited to biocides, surfactants, and proppants can be mixed into the fracturing fluid. In various embodiments, the pump 20 (e.g., a low pressure pump, a high pressure pump, or a combination thereof) may convey the fracturing fluid from the mixing tank 10 to the working string 16. The fracturing fluid may also be formulated offsite and transported to a worksite, in which case the fracturing fluid may be introduced to the working string via the pump 20 directly from its shipping container (e.g., a truck, a railcar, a barge, or the like) or from a transport pipeline. In either case, the fracturing fluid may be drawn into the pump 20, elevated to an appropriate pressure, and then introduced into the working string for delivery downhole.

In one or more embodiments, the pump 20 may be a high pressure pump. As used herein, the term “high pressure pump” will refer to a pump that is capable of delivering a fluid downhole at a pressure of about 1000 psi or greater. A high pressure pump may be used when it is desired to introduce the fracturing fluid to a treatment zone at or above a fracture gradient of the subterranean formation, but it may also be used in cases where fracturing is not desired. In one or more embodiments, the high pressure pump may be capable of fluidly conveying particulate matter, such as proppant particulates, into the treatment zone. Suitable high pressure pumps will be known to one having ordinary skill in the art and may include, but are not limited to, floating piston pumps and positive displacement pumps.

In one or more embodiments, the pump may be a low pressure pump. As used herein, the term “low pressure pump” will refer to a pump that operates at a pressure of about 1000 psi or less. In one or more embodiments, a low pressure pump may be fluidly coupled to a high pressure pump that is fluidly coupled to the working string 16. That is, in such embodiments, the low pressure pump may be configured to convey the fracturing fluid to the high pressure pump. In such embodiments, the low pressure pump may “step up” the pressure of the fracturing fluid before it reaches the high pressure pump.

The working string 16 may comprise coiled tubing, jointed pipe, and/or other structures that allow fluid to flow into the wellbore 30. The working string 16 may further include flow control devices (not shown) that control the flow of fluid from the interior of the working string 16 into the treatment zone 32.

In one or more embodiments, the working string 16 and/or the wellbore 30 may include one or more sets of packers 50a, 50b that seal the annulus between the working string 16 and wellbore 30 to define an interval of the wellbore into which fracturing fluid will be pumped. As illustrated, the fracturing system can comprise two sets of packers 50a and 50b, one defining an uphole boundary and one defining a downhole boundary. When the fracturing fluid is introduced into wellbore at a sufficient hydraulic pressure, one or more fractures 60 may be created in the treatment zone. The proppant particulates in the fracturing fluid may enter the fractures 60 where they may remain after the fracturing fluid flows out of the wellbore 30. These proppant particulates may prop fractures such that fluids may flow more freely through the fractures 60.

After introduction of the full amount of the calculated or estimated volume of fracturing fluid necessary to fracture the formation and optionally transport the desired quantity of proppant material into the created fracture, the wellbore may be shut-in for a period of time sufficient to permit stabilization of the subterranean formation. In one or more embodiments, the wellbore is shut-in for a period of time to permit the formation to at least partially close upon the proppant material and stabilize the fracture volume. The shut-in period can be from several minutes to in excess of about 12 hours and, preferably, is in the range of from about 0.5 to 2 hours. After the treatment zone has stabilized, the wellbore 30 may be opened under controlled conditions and the pressure drop in the wellbore causes the fracturing fluid to expand toward the wellbore. The fracturing fluid then moves from the formation into the wellbore and exits the wellbore at the surface. The expanding gas may carry a substantial portion of the liquids present in the fracturing area from the formation thereby leaving the formation and wellbore clean and ready for the commencement of production.

The methods and compositions of the embodiments may be suitable for use in nearly all subterranean formations. However, in one or more embodiments the fracturing fluid may be particularly well suited for use in a formation with water-sensitive clay formations, including smectite, vermiculite, illite, kaolinite, chlorite, and mixed-layer smectite-illite.

It is to be recognized that the system depicted in FIG. 1 is merely exemplary in nature and that various additional components may be present that have not necessarily been depicted in the interest of clarity. Non-limited additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

### Hydraulic Fracturing Fluid

In one or more embodiments the fracturing fluid comprises an aqueous base fluid. Aqueous base fluids suitable for use in the fracturing fluid include fresh water, saltwater (e.g., water containing one or more salts dissolved therein), brine (e.g., saturated salt water or produced water), seawater, produced water (e.g., water produced from subterranean formation) or combinations thereof. Generally, the water may be from any source. Preferably, the water does not contain components that might adversely affect the stability of the fracturing fluid. In one or more embodiments, properties of the aqueous base fluid such as density and pH can be adjusted as would be readily understood by one of ordinary skill in the art.

In one or more embodiments the fracturing fluid also comprises about 0.001 to about 1 wt. % of cationic polymer. In an exemplary embodiment, the cationic polymer is cationic hydroxyethyl cellulose (cat-HEC). Other examples of useful cationic polymers include, but are not limited to quaternary hydroxyl alkyl cellulose (SOFTCAT® by DOW®, SENSOMER® and MERQUAT® by LUBRIZOL®), cationic polygalactomannan gum; amine treated cationic starches; ethanol, 2,2,2-nitrilotris-, polymer with 1,4-dichloro-2-butene and N,N,N′,N′-tetramethyl-2-butene-1,4-diamine; poly[bis(2-chloroethyl) ether-alt-1,3-bis[3-(dimethylamino)propyl]urea]; hydroxyethyl cellulose dimethyl diallylammonium chloride copolymer; diallyldimethylammonium chloridehydroxyethyl cellulose copolymer; copolymer of acrylamide and quaternized dimethylammoniumethyl methacrylate; poly(diallyldimethylammonium chloride); copolymer of acrylamide and diallyldimethylammonium chloride; quaternized hydroxyethyl cellulose; copolymer of vinylpyrrolidone and quaternized dimethylaminoethyl methacrylate; acrylamidedimethylaminoethyl methacrylate methyl chloride copolymer; copolymer of vinylpyrrolidone and quaternized vinylimidazole; copolymer of acrylic acid and diallyldimethylammonium chloride; copolymer of vinylpyrrolidone and methacrylamidopropyl trimethylammonium; poly(acrylamide 2-methacryloxyethyltrimethyl ammonium chloride); poly(2-methacryloxyethyltrimethylammonium chloride); terpolymer of acrylic acid, acrylamide and diallyldimethylammonium chloride; poly[oxyethylene(dimethylimino)ethylene (dimethylimino)ethylene dichloride]; terpolymer of vinylcaprolactam, vinylpyrrolidone, and quaternized vinylimidazole; polyquaternium-47 terpolymer of acrylic acid, methacrylamidopropyl trimethylammonium chloride, and methyl acrylate; guar hydroxypropyltrimonium chloride; poly(ethyleneimine) (PEI); poly-L-(lysine) (PLL); poly[2-(N,N-dimethylamino)ethyl methacrylate](PDMAEMA) and chitosan; cellulose, 2-(2-hydroxy-3-(trimethylammonium)propoxy)ethyl ether chloride, and combinations thereof.

In one or more embodiments, the cationic polymer comprises a combination of two or more cationic functional groups, such as trimethylammonium chloride, quaternized vinylimidazole.

In one or more embodiments, the cationic polymer is water-soluble. As used herein, the term “water-soluble” means that at least 1 gram of the cationic cellulose is soluble in 100 grams of distilled water at 25° C. and 1 atmosphere. The extent of water solubility is controlled by the level of substituent groups, including the cationic groups, attached to the cellulose derivative. Techniques for varying solubility are known to those having ordinary skill in the art.

In one or more embodiments, the molecular weight of the cationic polymer is varied in order to preserve a long half-life. In one or more embodiments, the cationic polymer comprises a high molecular weight polymer and a lower molecular weight polymer, the “low” and “high” terms being relative to each other. The high molecular weight polymer has a molecular weight of about 500K to about 2.5 million. For example, the high molecular weight polymer has a molecular weight of about 600K. In one or more embodiments, the low molecular weight polymer has a molecular weight of about 2K to about 400K. For example, the low molecular weight polymer has a molecular weight of about 2K. In one or more embodiments, a 3:1 mixture of high molecular weight to low molecular weight polymer was utilized.

In one or more embodiments the fracturing fluid can include 0.1 to 10 wt. % of one or more salts, including but not limited to potassium chloride, calcium chloride, sodium chloride, and ammonium chloride. In one or more embodiments, the salt is selected from potassium chloride and sodium chloride. In one or more embodiments, the fracturing fluid may include salt from salt water. For example, the salt water may include one or more of source water, seawater, saltwater, brine, produced water, and flowback water.

In one or more embodiments, the fracturing fluid may further comprise a plurality of proppant particulates. Proppant particulates suitable for use may comprise any material suitable for use in subterranean operations. Suitable materials include, but are not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, resin coated sand, and any combination thereof. The proppant can have sufficient compressive strength to resist crushing, and also can be sufficiently non-abrasive and non-angular to preclude cutting and embedding into the formation.

In one or more embodiments the fracturing fluid may also include one or more surfactants that may reduce the surface tension in the fracturing fluid such as lauryl sulfate, ethanol, naphthalene, methanol, isopropyl alcohol, 2-butoxyethanol, as well as other surfactants known by those of skill in the art. As would be readily understood by those having ordinary skill, any surfactant which aids in the dispersion and/or stabilization of the fracturing fluid may be used.

In one or more embodiments the fracturing fluid may also include one or more biocides that kill bacteria and other organisms that could produce gases such as glutaraldehyde, quaternary ammonium chloride, tetrakis hydroxymethyl-phosphonium sulfate, as well as other biocides know by those of skill in the art.

In one or more embodiments the fracturing fluid may also include one or more friction reducers that minimize fluid friction such as polyacrylamide, petroleum distillate, hydrotreated light petroleum distillate, methanol, ethylene glycol, as well as other friction reducers known by those of skill in the art. An example of a friction reducer is Halliburton Energy Service's FR-48W™ product.

In one or more embodiments the fracturing fluid may also include one or more gelling agent breakers (“gel breakers” or “breakers”) that reduce the viscosity of the fracture fluid such as ammonium persulfate, sodium, chloride, as well as other breakers known by those of skill in the art. An example of a breaker is Halliburton Energy Service's SP Breaker product.

In one or more embodiments the fracturing fluid may also include one or more buffering agents that adjust the pH of the fluid such as sodium carbonate, potassium carbonate, as well as other buffering agents known to those of skill in the art. An example of a buffering agent is Halliburton Energy Service's BA20™ product.

In one or more embodiments the fracturing fluid may also include one or more tackifying agents (or generally referred to as surface modification agents “SMAs”) that make the proppant tacky such as a resin or other SMA known to those of skill in the art. An example of an SMA is Halliburton Energy Service's SANDWEDGE® product.

In one or more embodiments the fracturing fluid may also include one or more corrosion inhibitors that mitigate damage from acidic fracturing fluid such as methanol, ammonium bisulfate, isopropanol, formic acid, acetaldehyde, as well as other corrosion inhibitors known to those of skill in the art. An example of a corrosion inhibitor is Halliburton Energy Service's ACROCLEAR® product.

In one or more embodiments the fracturing fluid may also include one or more gel stabilizers (or gelling agent) that increase the viscosity of the fracturing fluid such as guar gum, petroleum distillate, hydrotreated light petroleum distillate, methanol, polysaccharide blend, ethylene glycol, as well as other gel stabilizers known to those of skill in the art. An example of a gel stabilizer is Halliburton Energy Service's GEL-STA™ product.

In one or more embodiments the fracturing fluid may also include one or more iron control agents that mitigate carbonate and sulfate compounds from precipitating to restrict fluid flow such as citric acid, acetic acid, thiglycolic acid, sodium erythorbate, ammonium chloride, ethylene glycol, polyacrylate, as well as other iron control agents known to those of skill in the art.

In one or more embodiments, the hydraulic fracturing system 1 is used to deliver the fracturing fluids described herein to a downhole location using the pump 20. The fracturing fluid enters working string 16 which extends from the wellhead 14 to the desired treatment zone 32, at which point the fracturing fluid exists the working string 16 and enters the formation at the desired treatment zone 32. When the fracturing fluid is introduced into the formation at a sufficient hydraulic pressure, one or more fractures 60 may be created in the treatment zone. The proppant particulates in the fracturing fluid may enter the fractures 60 where they may remain after the fracturing fluid flows out of the wellbore 30. These proppant particulates may prop fractures such that fluids may flow more freely through the fractures 60.

All clay minerals belong to the same class of minerals: silicates. All clays are layered silicates and consist of different arrangements of the same basic units: oxygen containing tetrahedral sheets and hydroxyl containing octahedral sheets. The tetrahedral sheets contain one silica atom central to four oxygen atoms. The octahedral sheet is formed by six hydroxyl groups surrounding a central cation, which is typically alumina but could be substituted with magnesium or iron. Each octahedral sheet can be either trioctahedral or dioctahedral. The trioctahedral sheets have 3 divalent cations and every cation site is occupied; this structure is often referred to as brucite [Mg(OH)3]. For the dioctahedral sheets there are only 2 trivalent cations, usually A13+, and every third cation site is unoccupied; these are typically referred to as Gibbsite [Al(OH)3]. Small changes in amount of the cation substitutions and orientation of the stacked layers cause the morphology, structure, and reactivity to change between clay types. Swelling occurs when foreign water contacts the formation and becomes absorbed into the clay layers. All clays have the ability to absorb water; some are just more efficient than others. The extent the clay will swell depends mostly on the strength of bonding between the layers, the size and nature of the counter ion and the fluid it encounters. The inclusion of the cationic polymer and salt combination stabilizes formation and decreases any reduction in the permeability of the formation. More specifically, the cationic polymer and salt combination reacts with the clay of the formation to prevent clay swelling and fines migration. The positive charge groups on the polymer and salt cations in the fracturing fluid bind to the negative charges on clay and provide stability. Additionally, the formation permeability is improved because the cationic polymer and salt combination act synergistically to stabilize the formation compared to either one additive acting alone. The salt primarily prevents clay swelling and enables the cationic polymer to act on fines, and together maintain the structural integrity of the formation, thus decreasing any breakdown of the formation's granular structure. The combination of decrease in swelling and maintaining structural integrity improves the production characteristics of the formation, such as permeability and porosity, allowing for increased production of fluids from the formation.

### Experimental Section

In an experiment to demonstrate the effects of various treatment fluids on clay, four samples of bentonite clay were mixed with different treatment fluids as shown in the chart below.

| SAMPLE | Bentonite Clay | Treatment Fluid |
|---|---|---|
| “A” | 2 milliliters | 10 milliliters of deionized water |
| “B” | 2 milliliters | 10 milliliters of deionized water |
| | | comprising 10 gallons per thousand (gpt) |
| | | CLA-WEB ^{®}, a non-toxic chemical |
| | | stabilizing additive used to control clay |
| | | swelling in oil and gas wells. |
| “C” | 2 milliliters | 10 milliliters of deionized water |
| | | comprising 1.4 wt. % KCl |
| “D” | 2 milliliters | 10 milliliters of deionized water |
| | | comprising 1.4 wt. % KCl and 0.6 wt. % |
| | | Cat-HEC |

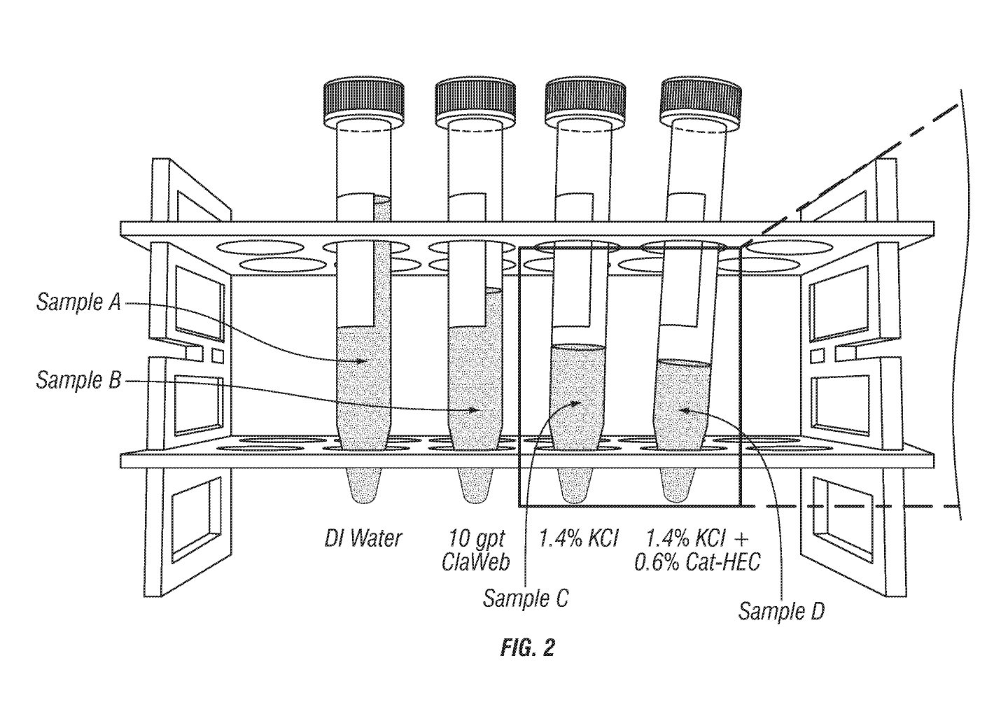

FIG. 2 illustrates the effects of the different treatment fluids on the bentonite clay. Sample A, which was treated with only deionized water, had significantly greater swelling than Samples B, C, and D. Sample B, which was treated with 10 gpt of CLA-WEB® had less swelling than Sample A, but still significantly more swelling than Samples C and D, each of which contained 1.4 wt. % KCl.

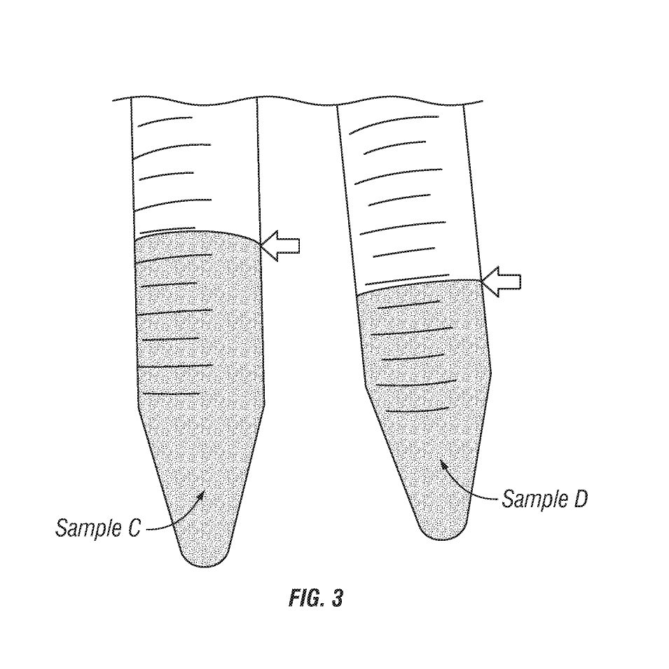

With reference to FIG. 3, which is a close up view of Samples C and D from FIG. 2, Sample D, which was treated with 1.4 wt. % KCl and 0.6 wt. % Cat-HEC, had less swelling than Sample C which contained 1.4 wt. % KCl and no Cat-HEC. In addition, it is noted that in Sample D the granularity of the bentonite clay is maintained, and thus the clay maintains its porosity. Conversely, in Sample C, the clay has begun to dissolve, thereby decreasing its structural integrity. The dissolving of the clay also results in a decrease in porosity which reduces the rate of oil flow from the formation. Thus, the use of a cationic polymer in combination with a salt provides low swelling and preservation of the structural integrity and porosity of the clay.

This discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

Certain terms are used throughout the description and claims to refer to particular features or components. As one skilled in the art will appreciate, different persons may refer to the same feature or component by different names. This document does not intend to distinguish between components or features that differ in name but not function, unless specifically stated. In the discussion and in the claims, the terms “including” and “comprising” are used in an open-ended fashion, and thus should be interpreted to mean “including, but not limited to.” Also, the term “couple” or “couples” is intended to mean either an indirect or direct connection. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

Although the present invention has been described with respect to specific details, it is not intended that such details should be regarded as limitations on the scope of the invention, except to the extent that they are included in the accompanying claims.

What is claimed is:

1. A formation fracturing fluid comprising:
an aqueous base fluid; and
a cationic polymer combined with a salt.

2. The fluid of claim 1, wherein the salt is selected from potassium chloride, calcium chloride, sodium chloride, ammonium chloride, or combinations thereof.

3. The fluid of claim 1 further comprising about 0.001 to about 10 wt. % salt.

4. The fluid of claim 1 further comprising about 1.4 wt. % salt.

5. The fluid of claim 1 further comprising about 0.001 to about 1 wt. % cationic polymer.

6. The fluid of claim 1 further comprising about 0.6 wt. % cationic polymer.

7. The fluid of claim 1, wherein the cationic polymer comprises cationic hydroxyethyl cellulose.

8. The fluid of claim 1, wherein the cationic polymer comprises a combination of two or more cationic functional groups.

9. The fluid of claim 8, wherein the two or more cationic functional groups are selected from at least one of trimethylammonium chloride, and quaternized vinylimidazole.

10. The fluid of claim 1, wherein the cationic polymer is water soluble.

11. The fluid of claim 1, wherein the cationic polymer is selected from quaternary hydroxyl alkyl cellulose, cationic polygalactomannan gum, and amine treated cationic starches.

12. The fluid of claim 1, wherein the cationic polymer includes at least one of guar, xanthan, synthetic polyacrylamide-based cationic polymers, and combinations thereof.

13. The fluid of claim 1, wherein the molecular weight of the cationic polymer ranges from about 500,000 to about 2.5 million.

14. The fluid of claim 1 further comprising at least one of a proppant material, a biocide, and a surfactant.

15. The fluid of claim 1, wherein the salt is from a salt water.

16. A method of performing an operation on a formation penetrated by a wellbore comprising:
introducing an aqueous fracturing fluid comprising a cationic polymer combined with a salt into the formation through the wellbore; and
creating fractures in the formation.

17. The method of claim 16, wherein the fracturing fluid comprises about 0.001 to about 10 wt. % salt.

18. The method of claim 16, wherein the fracturing fluid comprises about 0.001 to about 1 wt. % cationic polymer.

19. The method of claim 16, further comprising pumping the fracturing fluid into the fractures.

20. The method of claim 19, further comprising producing fluids from the formation.

21. The method of claim 19, wherein the salt is from a salt water.

22. A chemical additive comprising a cationic polymer combined with a salt.

23. The chemical additive of claim 22, the cationic polymer combined with salt being combinable with an aqueous base fluid to form a formation fracturing fluid.

24. The chemical additive of claim 22, wherein the salt is from a salt water.
